(19) United States
(12) Patent Application Publication
(10) Pub. No.: US 2012/0133744 A1
(43) Pub. Date: May 31, 2012

(54) STEREOSCOPIC IMAGE GENERATION APPARATUS AND METHOD

(75) Inventor: Kun-Hui LAI, TAIPEI CITY (TW)

(73) Assignee: INVENTEC CORPORATION, Taipei City (TW)

(21) Appl. No.: 13/031,614

(22) Filed: Feb. 22, 2011

(30) Foreign Application Priority Data
Nov. 25, 2010 (CN) 201010569140.2

(51) Int. Cl. H04N 13/02

(52) U.S. Cl. 348/49; 348/E13.074

(57) ABSTRACT

A stereoscopic image generation method includes the following steps. A right-eye image is taken along a first direction. A left-eye image is taken along a second direction. A right portion of the left-eye image is trimmed off by a predetermined distance, and a left portion of the right-eye image is trimmed off by the predetermined distance, such that the trimmed left-eye image and the trimmed right-eye image have the same size.

### RELATED APPLICATIONS

This application claims priority to China Application Serial Number 201010569140.2, filed Nov. 25, 2010, which is herein incorporated by reference.

### BACKGROUND

1. Field of Invention

The present invention relates to an image generation apparatus and an image generation, and more particularly, to a stereoscopic image generation apparatus and a stereoscopic image generation.

2. Description of Related Art

Recently, a 3D screen is gradually entering the market and is expected to become mainstream in the next two or three years. Accordingly, it is believed that a mechanism for generating a stereoscopic image also will be developed rapidly and flourishingly. Particularly, the instant video messaging software (e.g. MSN and ICQ) applicable on a portable electronic device (e.g. a notebook computer or a laptop computer) or a handheld communication device (e.g. a cell phone) will generate a future demand for seeing a counterpart's stereoscopic image. On such an application, the “real-timeness” of the stereoscopic image is more important and concerned than the “resolution” of the stereoscopic image is.

In general, a stereoscopic image is a combination of two images, which are transmitted respectively to a user's left and right eyes for creating an illusion for the user. Thus, a manner for generating the stereoscopic image is just to simulate the images seen by the user's left and right eyes. Therefore, the simplest conventional method is to dispose two photographing lenses which are spaced about 6 cm apart on an electronic device, thereby respectively simulating the images seen by the left eye and the right eye.

However, disposing such two photographing lenses may increase additional hardware cost.

### SUMMARY

In order to solve the aforementioned problems of the conventional art, a technical aspect of the present invention is to provide a stereoscopic image generation method, which simulates and generates a stereoscopic image by using a difference between view angles after a right-eye image and a left-eye image are obtained merely by one single photographing lens with a small-angle rotation. Therefore, no extra photographing lens needs to be disposed, thus saving hardware cost.

According to an embodiment of the present invention, the stereoscopic image generation method includes the following steps. The right-eye image is taken along a first direction. The left-eye image is taken along a second direction. The right portion of the left-eye image is trimmed off by a predetermined distance to obtain a trimmed left-eye image, and the left portion of the right-eye image is trimmed off by the predetermined distance to obtain a trimmed right-eye image, so that the trimmed left-eye image and the trimmed right-eye image have the same size.

Another technical aspect of the present invention is to provide a stereoscopic image generation apparatus.

According to another embodiment of the present invention, the stereoscopic image generation apparatus includes an image capture module, an actuating module, a driving chip, an image trimming module and an image composition module. The driving chip can be used for driving the actuating module to actuate the image capture module to take a right-eye image along a first direction, driving the actuating module to actuate the image capture module to take a left-eye mage along a second direction, driving the image trimming module to trim off the right portion of the left-eye image by a predetermined distance to obtain a trimmed left-eye image and to trim off the left portion of the right-eye image by the predetermined distance to obtain a trimmed right-eye image, thereby making the left-eye image and the trimmed right-eye image have the same size; and driving the image composition module to alternately arrange each pixel in the trimmed left-eye image and each pixel in the trimmed right-eye image in sequence.

In order to make the foregoing as well as other aspects, features and advantages of the present invention more apparent, hereinafter preferred embodiments for exemplification are described in detail with reference to the accompanying drawings.

It is to be understood that both the foregoing general description and the following detailed description are by examples, and are intended to provide further explanation of the present invention as claimed.

### BRIEF DESCRIPTION OF THE DRAWINGS

In order to make the foregoing as well as other aspects, features, advantages, and embodiments of the present invention more apparent, the accompanying drawings are described as follows:

FIG. 1 is a step flow chart showing a stereoscopic image generation method according to an embodiment of the present invention;

FIG. 2 is a schematic view illustrating a right-eye image and a left-eye image which are taken from a reference point and are translated to respectively simulate the images actually seen by a right eye and a left eye;

FIG. 3A is a schematic view of a taken left-eye image;

FIG. 3B is a schematic view illustrating a translation of the left-eye image in FIG. 3A;

FIG. 3C is a schematic view of a taken right-eye image;

FIG. 3D is a schematic view illustrating a translation of the right-eye image in FIG. 3C;

FIG. 4 is a schematic view illustrating a trimmed right-eye image and a trimmed left-eye image which are combined into a stereoscopic image;

FIG. 5 is a stereoscopic view of an electronic device using a stereoscopic image generation apparatus according to an embodiment of the present invention;

FIG. 6 is a functional block diagram showing the stereoscopic image generation apparatus shown in FIG. 5;

FIG. 7A is a cross-sectional view of the electronic device in FIG. 5 viewed along a line C-C;

FIG. 7B is a cross-sectional view illustrating an actuating module in FIG. 7A which actuates an image capture module to face toward a first direction; and

FIG. 7C is a cross-sectional view illustrating that the actuating module in FIG. 7A which actuates the image capture module to face toward a second direction.

### DETAILED DESCRIPTION

A plurality of embodiments of the present invention are disclosed with reference to the drawings, and for the purpose of clarity, various details in practice will also be illustrated in the following description. However, it should be appreciated that these details in practice should not be considered to limit the present invention. That is to say, these details in practice are not necessary in some embodiments of the present invention. Moreover, in order to simplify the drawings, some conventional structures and elements are illustrated schematically.

A technical aspect of the present invention is to provide a stereoscopic image generation method. More particularly, the present invention mainly aims to simulate and generate a stereoscopic image by using a difference between view angles after a right-eye image and a left-eye image are obtained merely by one single photographing lens with a small-angle rotation, thereby saving the conventional hardware cost of disposing two sets of photographing lenses. The specific embodiments of the present invention will be described in detail below, thereby fully illustrating features, spirit and advantages of the present invention and the convenience on implementation.

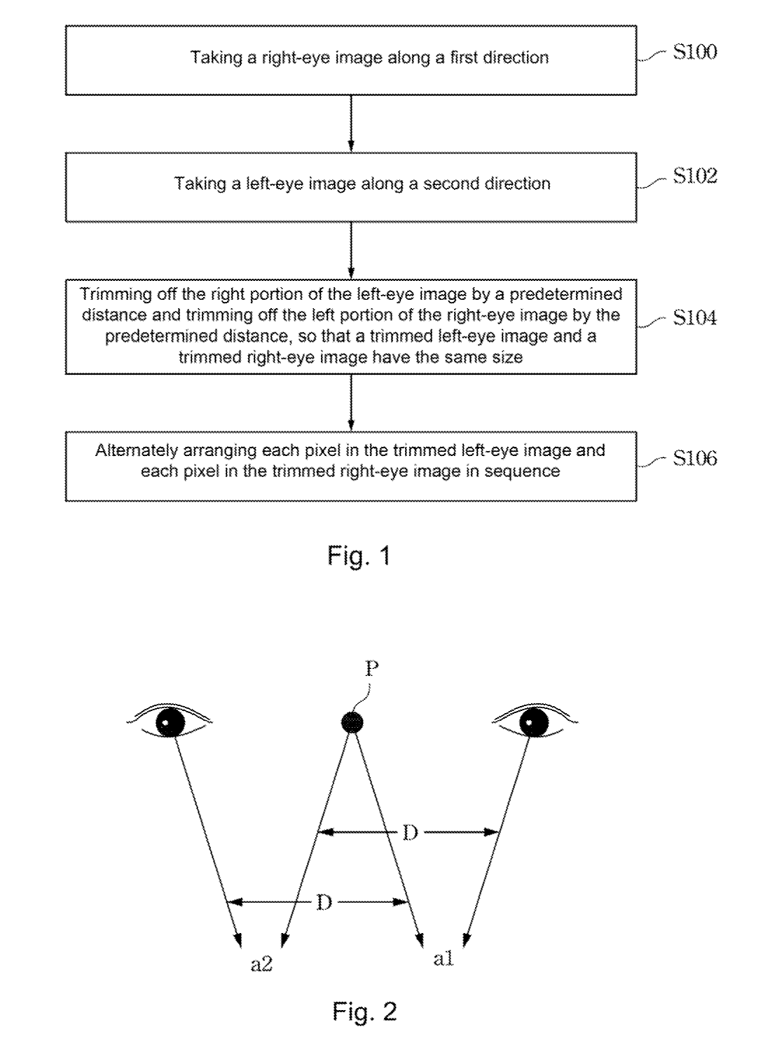

Referring to FIG. 1, FIG. 1 is a flow chart showing the steps of a stereoscopic image generation method according to an embodiment of the present invention. As shown in FIG. 1, the stereoscopic image generation method of this embodiment includes the following steps:

S100: a right-eye image is taken along a first direction.

S102: a left-eye image is taken along a second direction.

Referring to FIG. 2, FIG. 2 is a schematic view illustrating that a right-eye image and a left-eye image which are taken from a reference point P and are translated to respectively simulate images actually seen by the right eye and the left eye. The stereoscopic image generation method according to this embodiment is mainly to simulate an image actually seen by the right eye through a right-eye image taken along a first direction a1, and to simulate an image actually seen by the left eye through a left-eye image taken along a second direction a2.

However, after the right-eye image and the left-eye image are obtained, the right-eye image and the left-eye image cannot be directly considered to be equivalent to the images actually seen by the right eye and the left eye. Since the right-eye image and the left-eye image are respectively taken along the first direction a1 and along the second direction a2 from the same reference point P, the images actually seen by the right eye and the left eye of the user cannot be simulated even though there is a angle difference between the first directional and the second direction a2 just like the view angle difference between the left eye and the right eye. In this case, the right-eye image and the left-eye image still need to be performed with a process of translation so as to be more conformable to the images actually seen by the right eye and the left eye respectively.

In order to simulate the image actually seen by the right eye by using the right-eye image and to simulate the image actually seen by the left eye by using the left-eye image, a distance between the left eye and the right eye of an ordinary person has to be known first. Commonly speaking, the distance between the left eye and the right eye of an ordinary person is generally 5-7 centimeters. Thus, if the right-eye image taken from the reference point P which is a median point between the two eyes is desired to simulate the image actually seen by the right eye, a predetermined distance D for translating the right-eye image must be 2.5-3.5 centimeters. It is the same for using the left-eye image to simulate the image actually seen by the left eye.

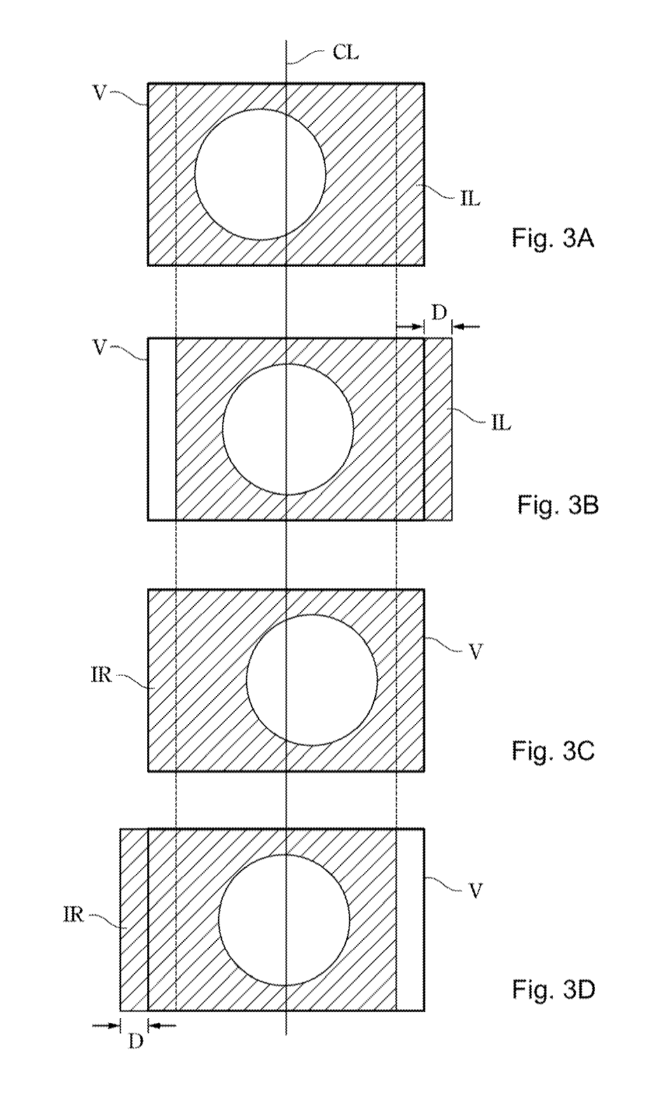

Refer to FIGS. 3A-3D. FIG. 3A is a schematic view of a taken left-eye image IL. FIG. 3B is a schematic view illustrating a translation of the left-eye image IL in FIG. 3A. FIG. 3C is a schematic view of a taken right-eye image IR. FIG. 3D is a schematic view illustrating a translation of the right-eye image IR in FIG. 3C.

As shown in FIG. 3A, it is first assumed that a boundary of the left-eye image IL is a view field range V seen by the left eye and the view field range V has a view angle median line CL. As shown in FIG. 3B, if the left-eye image IL of FIG. 3A is desired to simulate an image actually seen by the left eye, the left-eye image IL has to be translated for the predetermined distance D toward a right direction relative to the view field range V, wherein the right portion of the left-eye image IL which exceeds the view field range V represents a portion which cannot be seen by the left eye, and thus the portion has to be trimmed off. Furthermore, since the left-eye image IL is translated for the predetermined distance D toward the right direction relative to the view field range V, a region with no image appears in the view field range V of FIG. 3B. Thus, in order to make the respective image areas at both sides of the view angle median line CL symmetrical to each other, the right portion of the left-eye image IL in the view field range V has to be trimmed off again by the predetermined distance D (i.e., a region of the left-eye image IL on the right side of a dotted line in the view field range V is trimmed off by the predetermined distance D). In other words, only the left-eye image IL on the left side of the dotted line shown in FIG. 3B (a trimmed left-eye image) can be used for simulating the image actually seen by the left eye.

Likewise, as shown in FIG. 3C, it is first assumed that a boundary of the right-eye image IR is also the view field range V seen by the right eye, and the view field range V has the view angle median line CL. As shown in FIG. 3D, if the right-eye image IR of FIG. 3C is desired to simulate an image actually seen by the right eye, the right-eye image IR has to be translated for the predetermined distance D toward a left direction relative to the view field range V, wherein the left portion of the right-eye image IR which exceeds the view field range V represents a portion which cannot be seen by the right eye and thus the portion has to be trimmed off. Furthermore, since the right-eye image IR is translated for the predetermined distance D toward the left direction relative to the view field range V, a region with no image appears in the view field range V of FIG. 3B. Thus, in order to make the respective image areas at both sides of the view angle median line CL symmetrical to each other, the left portion of the right-eye image IR in the view field range V has to be trimmed off again by the predetermined distance D (i.e., a region of the right-eye image IR on the left side of a dotted line in the view field range V is trimmed off by the predetermined distance D). In other words, only the right-eye image IR on the right side of the dotted line in FIG. 3D (a trimmed right-eye image) can be used for simulating the image actually seen by the right eye. As can be clearly known from FIGS. 3B and 3D, the left-eye image IL on the left of the dotted line and the right-eye image IR on the right of the dotted line have the same size.

Thus, as shown in FIG. 1, the stereoscopic image generation method of this embodiment may further include the following step:

S104: the right portion of the left-eye image is trimmed off by a predetermined distance to obtain a trimmed left-eye image, and the left portion of the right-eye image is trimmed off by the predetermined distance to obtain a trimmed right-eye image, so that the trimmed left-eye image and the trimmed right-eye image have the same size.

In a specific embodiment, as shown in FIG. 1, the stereoscopic image generation method of this embodiment may further include the following step:

S106: each pixel in the trimmed left-eye image and each pixel in the trimmed right-eye image are alternately arranged in sequence.

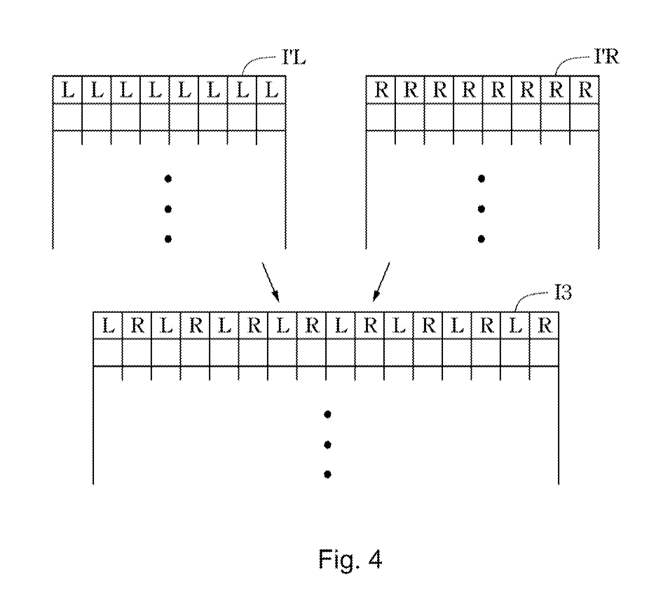

Referring to FIG. 4, FIG. 4 is a schematic view illustrating a trimmed left-eye image I′L and a trimmed right-eye image I′R which are combined into a stereoscopic image I3. However, an arrangement manner of the trimmed left-eye image I′L and the trimmed right-eye image I′R is not limited to the schematic view shown in FIG. 4. For example, an aspect of step S110 for composing the trimmed left-eye image I′L and the trimmed right-eye image I′R can be achieved based on column or in row by alternately arranging pixels in each column or row of the trimmed left-eye image I′L and pixels in each column or row of the trimmed right-eye image I′R in sequence. As to first arranging the trimmed left-eye image I′L or the trimmed right-eye image I′R, embodiments of the present invention are not limited to the one shown in FIG. 4, and can be flexibly determined as required.

Moreover, in order to truly simulate images seen by the left eye and the right eye of a person, an included angle between the aforementioned first direction a1 and the aforementioned second direction a2 is about 5.7-6 degrees. Therefore, if it an object is located 60 centimeters in front of the reference point P and a distance between the left eye and the right eye is 6 centimeters, an included angle between a direction along which the left eye sees the object and a direction along which the right eye sees the object can be calculated according to the following formula:

6/60/2π=5.7 (degrees)

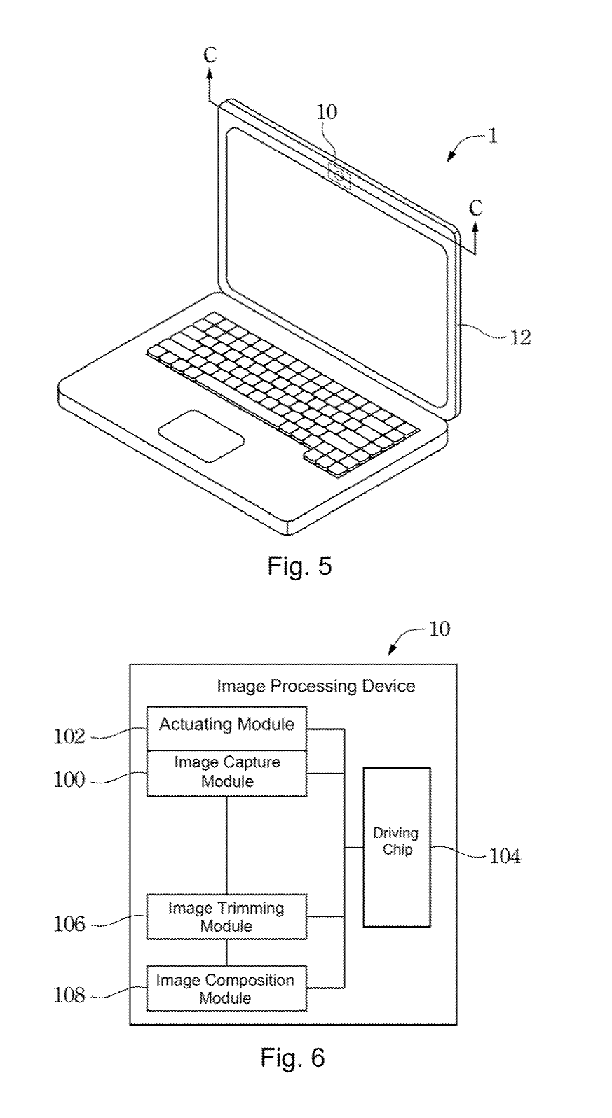

Another technical aspect of the present invention is to provide an apparatus for generating a stereoscopic image. Referring to FIG. 5, FIG. 5 is a stereoscopic view of an electronic device 1 using a stereoscopic image generation apparatus 10 according to an embodiment of the present invention. As shown in FIG. 5, the electronic device 1 is represented by a notebook computer, for example, but is not limited thereto. For example, a portable computer system such as a laptop computer also can be used as the electronic device 1. The stereoscopic image generation apparatus 10 of this invention can be disposed in a housing 12 of the electronic device 1 (e.g. a display housing of a notebook computer).

Referring to FIG. 6, FIG. 6 is a functional block diagram showing the stereoscopic image generation apparatus 10 shown in FIG. 5. As shown in FIG. 6, the stereoscopic image generation apparatus 10 includes an image capture module 100, an actuating module 102 and a driving chip 104. The actuating module 102 is operatively connected with the image capture module 100. Thus, the driving chip 104 can be used for driving the actuating module 102 to actuate the image capture module 100 to take the right-eye image IR as shown in FIG. 3C along the first direction; and driving the actuating module 102 to actuate the image capture module 100 to take the left-eye image IL as shown in FIG. 3A along the second direction.

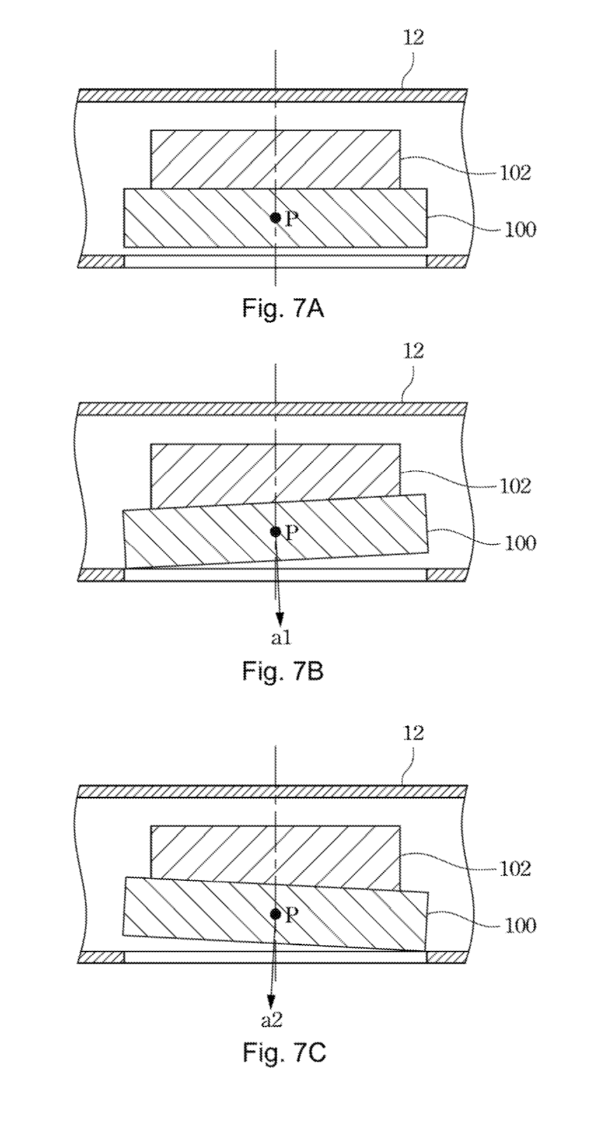

Refer to FIGS. 7A-7C. FIG. 7A is a cross-sectional view of the electronic device 1 in FIG. 5 viewed along a line C-C. FIG. 7B is a sectional view illustrating the actuating module 102 in FIG. 7A which actuates the image capture module 100 to face toward the first direction a1. FIG. 7C is a cross-sectional view illustrating the actuating module 102 in FIG. 7A which actuates the image capture module 100 to face toward the second direction a2. As shown in FIGS. 7A-7C, the aforementioned actuating module 102 can be used for turning the image capture module 100 from the first direction a1 toward the second direction a2. In other words, the image capture module 100 takes the right-eye image IR and the left-eye image IL based on the same reference point P, which is the greatest difference between the present invention and the conventional art which uses two photographing lenses. A range of the included angle between the first direction a1 and the second direction a2 and an assumption precondition has been described above and will not be described herein again.

In a specific embodiment, the aforementioned actuating module 102 may be a piezoelectric actuator, a static capacitance actuator, an electromagnetic actuator or a micro-electromechanical actuator.

After the right-eye image IR and the left-eye image IL are obtained, in order to enable the right-eye image IR and the left-eye image IL to respectively simulate images actually seen by the right eye and the left eye of the user, the right-eye image IR and the left-eye image IL still need to be performed with a process of translation so as to be more conformable to the images actually seen by the right eye and the left eye respectively.

Likewise, as shown in FIG. 6, in this embodiment, the stereoscopic image generation apparatus 10 can further include an image trimming module 108. The driving chip 104 is used for driving the image trimming module 108 to trim off the left-eye image IL and the right-eye image IR by the predetermined distance D (the actual trimming distance is twice of the predetermined distance D).

Furthermore, with reference to FIGS. 3A-3D, FIG. 4 and the relevant description above, the aforementioned image trimming module 108 can be used for trimming off the right portion of the left-eye image IL by the predetermined distance D (the actual trimming distance is twice of the predetermined distance D) and trimming off the left portion of the right-eye image IR by the predetermined distance D (the actual trimming distance is twice of the predetermined distance D), so that a trimmed left-eye image I′L and a trimmed right-eye image I′R have the same size, which will not be described herein again.

Likewise, as shown in FIG. 6 and with reference to FIG. 4, in this specific embodiment, the stereoscopic image generation apparatus 10 may further include an image composition module 110. In this case, the driving chip 104 can drive the image composition module 110 to combine the trimmed left-eye image and the trimmed right-eye image I′R.

Furthermore, the aforementioned image composition module 110 can be used for alternately arranging each pixel in the trimmed left-eye image and each pixel in the trimmed right-eye image I′R in sequence.

Certainly, the aforementioned image composition module 110 can also based on columns or rows to alternately arrange pixels in each column or row of the trimmed left-eye image I′L and the trimmed right-eye image I′R in sequence, which can also achieve the aspect of composing the trimmed left-eye image I′L and the trimmed right-eye image I′R. As to first arranging the trimmed left-eye image I′L or the trimmed right-eye image I′R, embodiments of the present invention are not limited and can be flexibly determined as required.

It is apparent from the detailed description regarding the embodiments of the present invention that, the stereoscopic image generation apparatus and the stereoscopic image generation method provided by the present invention are mainly an improvement of a conventional system architecture for generating a stereoscopic image with two photographing lenses. The present invention simulates and generates the stereoscopic image by using a difference between view angles after a right-eye image and a left-eye image are obtained merely by one single photographing lens with a small-angle rotation. Therefore, no extra photographing lens needs to be disposed, thereby saving the hardware cost. Moreover, since only one single image capture module is used, color consistency is higher in terms of image composition, and thus a display effect of the stereoscopic image will be better.

Although the present invention has been disclosed with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A stereoscopic image generation method, comprising:
taking a right-eye image along a first direction;
taking a left-eye image along a second direction; and
trimming off the right portion of the left-eye image by a predetermined distance to obtain a trimmed left-eye image and trimming off the left portion of the right-eye image by the predetermined distance to obtain a trimmed right-eye image, such that the trimmed left-eye image and the trimmed right-eye image have the same size.

2. The stereoscopic image generation method of claim 1, further comprising:
combining the trimmed left-eye image and the trimmed right-eye image.

3. The stereoscopic image generation method of claim 2, wherein the step of combining the trimmed left-eye image and the trimmed right-eye image further comprises:
alternately arranging each pixel in the trimmed left-eye image and each pixel in the trimmed right-eye image in sequence.

4. The stereoscopic image generation method of claim 1, wherein the predetermined distance is 2.5-3.5 centimeters.

5. The stereoscopic image generation method of claim 1, wherein an included angle between the first direction and the second direction is 5.7-6 degrees.

6. A stereoscopic image generation apparatus, comprising:
a driving chip;
an actuating module;
an image capture module, wherein the driving chip is used for driving the actuating module to actuate the image capture module to take a right-eye image along a first direction, and driving the actuating module to actuate the image capture module to take a left-eye image along a second direction; and
an image trimming module, wherein the driving chip is used for driving the image trimming module to trim off the right portion of the left-eye image by a predetermined distance to obtain a trimmed left-eye image and to trim off the left portion of the right-eye image by the predetermined distance to obtain a trimmed right-eye image, such that the trimmed left-eye image and the trimmed right-eye image have the same size.

7. The stereoscopic image generation apparatus of claim 6, futhur comprising an image composition module, wherein the driving chip is used for driving the image composition module to alternately arrange each pixel in the trimmed left-eye image and each pixel in the trimmed right-eye image in sequence.

8. The stereoscopic image generation apparatus of claim 6, wherein the predetermined distance is 2.5-3.5 centimeters.

9. The stereoscopic image generation apparatus of claim 6, wherein an included angle between the first direction and the second direction is 5.7-6 degrees.

10. The stereoscopic image generation apparatus of claim 6, wherein the actuating module is selected from a group consisting of a piezoelectric actuator, a static capacitance actuator, an electromagnetic actuator and a micro-electromechanical actuator.
